(19) United States
(12) Patent Application Publication
(10) Pub. No.: US 2007/0236170 A1
(43) Pub. Date: Oct. 11, 2007

(54) Battery enclosure

(76) Inventor: Matthew W. Reed, New Boston, NH (US)

Correspondence Address: INSIGHT TECHNOLOGY, INC.;ATTN: PETER W. MURPHY, NINE AKIRA WAY, LONDONDERRY, NH, 03053, US

(21) Appl. No.: 11/374,581

(22) Filed: Mar. 13, 2006

Related U.S. Application Data
(60) Provisional application No. 60/660,791, filed on Mar. 11, 2005.

(51) Int. Cl. H02J 7/00

(52) U.S. Cl. 320/107

(57) ABSTRACT

A battery enclosure includes an electrical circuit that allows the batteries to be inserted in an enclosure all in the same orientation.

### CROSS REFERENCE TO RELATED APPLICATIONS

The present application claims the benefit of U.S. provisional patent application Ser. No. 60/660,791, filed Mar. 11, 2006, the entire disclosures of which is incorporated herein by reference.

### TECHNICAL FIELD

The present invention is generally related to electronic devices requiring battery power, more particularly, to systems and methods for arranging multiple batteries in a housing.

### BACKGROUND OF THE INVENTION

Many electronic devices rely on power provided from one or more dry cell batteries that must be inserted within a housing in a certain orientation in order to safely provide the proper voltage. The batteries may fit within the electronic device itself or may be housed in a separate enclosure and be coupled by a cord.

Night vision systems include image intensification, thermal imaging, and fusion monoculars, bioculars, binoculars, and goggles, whether hand-held, weapon mounted, or helmet mounted. In helmet-mounted applications, a battery pack may be coupled to the back of the helmet with a releasable connector and electrically coupled to the monocular, bioculars, binoculars, or goggles with a cable having a connector at one or both ends.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is a schematic of a battery enclosure consistent with one embodiment of the present invention.

FIG. 2 is a side view of a vision system consistent with one embodiment of the present invention.

FIG. 3 is an isometric view of a battery enclosure consistent with one embodiment of the present invention.

FIG. 4 is an isometric view of internal components of the battery enclosure of FIG. 3.

### DETAILED DESCRIPTION

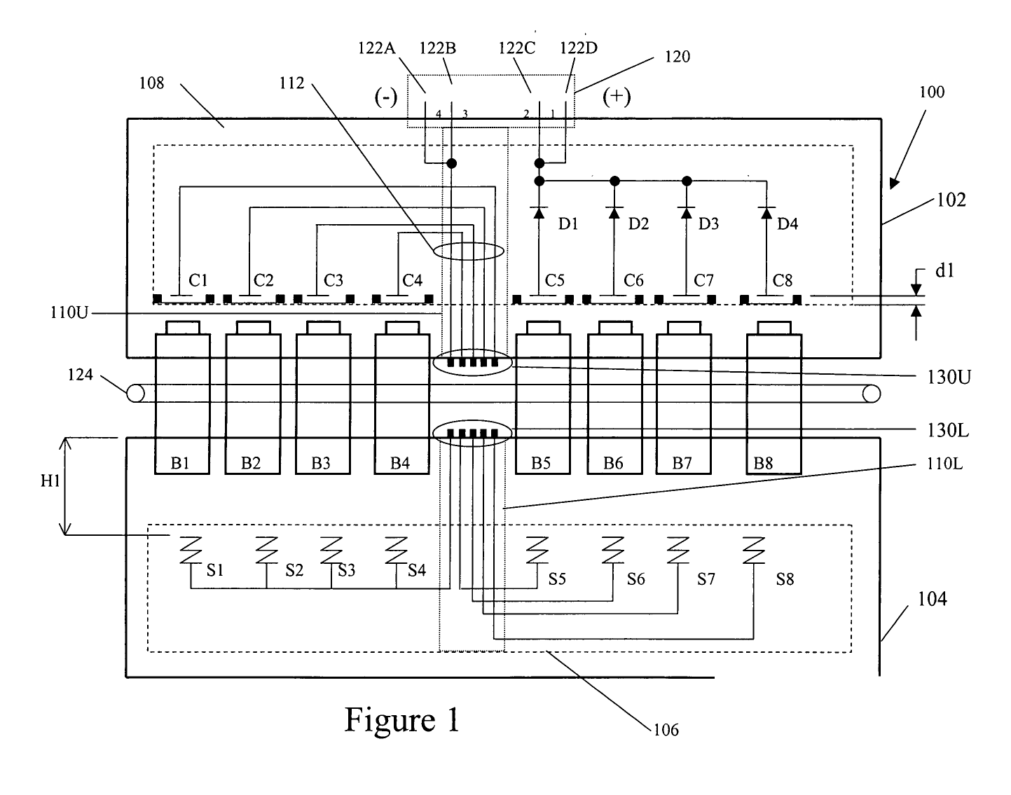

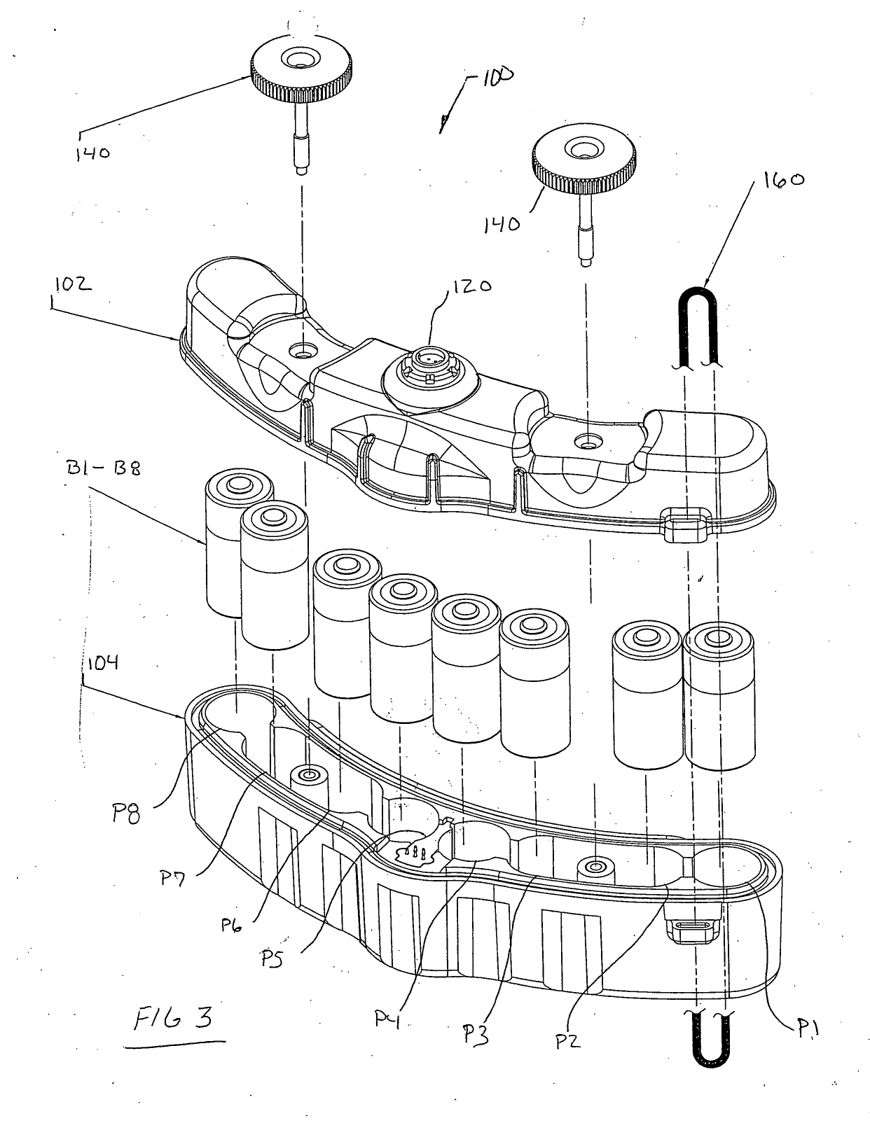

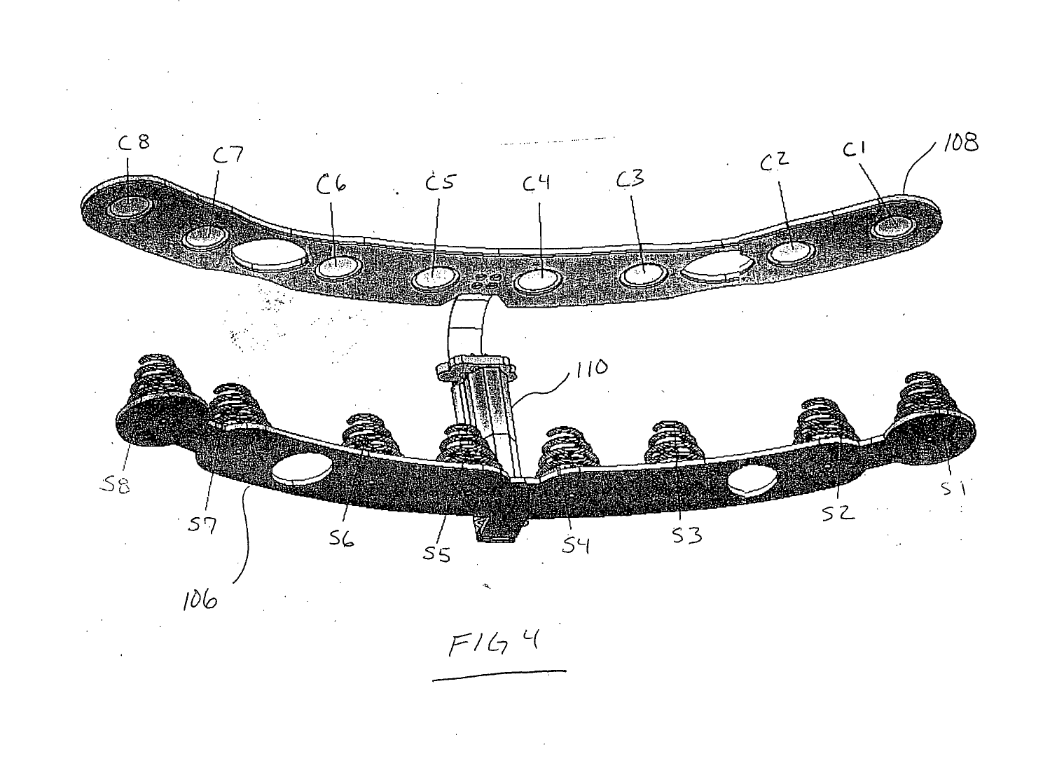

FIG. 1 is a schematic and FIGS. 3 and 4 are isometric views of a battery enclosure consistent with one embodiment of the present invention. The enclosure 100 may have an upper housing 102 and a lower housing 104 in which two or more batteries B1-B8 may be inserted. Each battery may be a dry cell, for example a DL123 and provide a DC voltage, for example 3vdc. The batteries B1-B8 may be inserted in the enclosure all in the same orientation (e.g. all +'s up) to simplify insertion. The bottoms of the batteries B1-B8 may rest on spring contacts S1-S8 coupled to a lower printed wiring board (PWB) 106 and the tops of the batteries B1-B8 may touch contacts C1-C8 coupled to an upper PWB 108. Alternatively, the spring contacts S1-S8 may be coupled to the upper PWB 108. A first connector 110 may include one or more conductors 112 for coupling the lower PWB 106 to the upper PWB 108. A second connector 120 may be connected to the upper PWB 108 and have two or more pins 122A-D for supplying a voltage to a coupled electronic device. One or more pins 122A, 122B may be negative and one or more pins 122C, 122D may be positive. Alternatively, the connector 120 may be coupled to the lower housing 104.

The contacts C1-C8 may be submerged from the lower surface of the upper PWB 108 a distance “d1” to prevent electrical contact from being made with a battery if the battery is installed upside down. Other mechanical features/spacers, for example protrusions, washers, or insulators, may be substituted to prevent electrical contact from being made with a battery if the battery is installed upside down.

The batteries B1-B8 may be inserted in pairs starting from the middle, for example B4 and B5 (e.g. 3vdc batteries) may be inserted to provide 6vdc for a determinable duration. Additional batteries B3 and B6; B2 and B7; and B1, B8 may be inserted for increased duration. When the batteries B4, B5; B3, B6; B2, B7; and B1, B8 are inserted, a potential equivalent to the series voltage across the battery pairs may be provided to the second connector 120. Eight batteries are shown, but other quantities may be used without departing from the invention.

One or more diodes D1-D4 or other electrical components may be electrically coupled to each battery or battery pair to prevent one battery from charging/discharging another battery.

The lower housing 104 of the battery enclosure 100 may have pockets P1-P8 for accepting the batteries B1-B8 and holding them generally upright. The batteries being disposed next to each other, and not arranged end-to-end. The pockets P1-P8 may be sized to allow the batteries B1-B8 to be easily inserted, but not tip away from vertical enough to hinder connection of the upper housing 102 to the lower housing 104. Before connecting the upper housing 102 to the lower housing 104, the batteries B1-B8 may rest on top of the uncompressed spring contacts S1-S8 and after connecting the upper housing 102 to the lower housing 104 the spring contacts S1-S8 may be compressed. The height H1 of the pockets P1-P8 from the top of the uncompressed spring contacts S1-S8 to the top of the lower housing 104 before the upper housing 102 is secured to the lower housing 104 may be designed such that greater than 50% of the battery is within the lower housing 104, more preferably greater than 60%. The pockets may be generally cylindrically shaped and sized to allow the batteries B1-B8 to be installed, but not move significantly from side-to-side. The diameter of the pocket may be within 0.030″ of the maximum specified diameter of the batteries B1-B8.

The first connector 110 may have an upper portion 110U and a lower portion 110L with a plurality of mating contacts 130U and 130L along a mating surface. First connector 110 may form part of an electrical circuit for electrically coupling the batteries B1-B8.

Threaded fasteners 140 may be used to secure the upper housing 102 to the lower housing 104 and a gasket 124 may provide a water-tight seal. A retainer 160 may be used to prevent separation of the upper housing 102 from the lower housing 104.

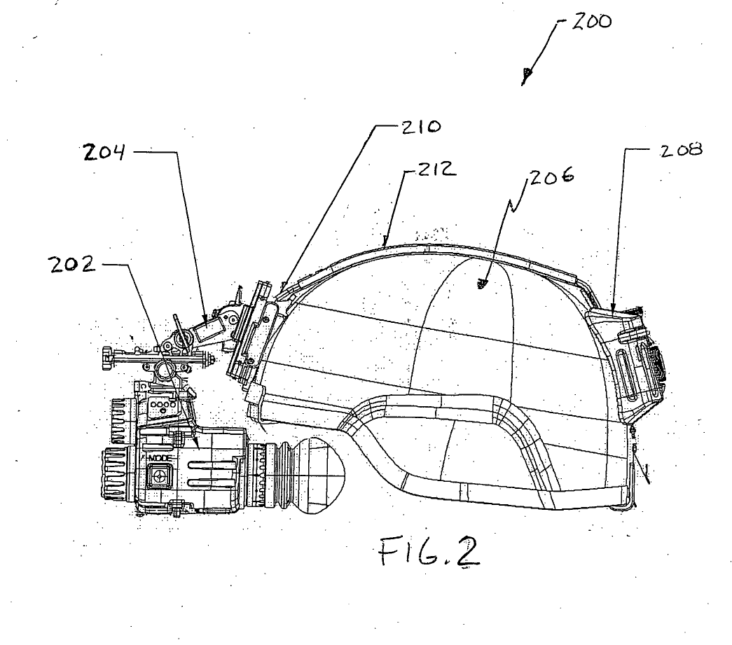

FIG. 2 is a side view of a vision system 200 consistent with the invention. The system 200 may include a night vision, thermal, or fusion system 202, a mounting assembly 204, a helmet 206, a battery pack 208, and a cable 210. The battery pack 208 may be contoured along one surface to cooperate with the contour of the helmet 206. The cable 210 may extend either inside or outside the helmet 204. A strap 212 may couple the vision system 202 and the battery pack 208 to the helmet 206. The strap 212 may have an opening through which the cable 210 may be threaded in order to reduce snag hazards. Alternatively, the battery pack 208 may be coupled to the helmet 206 with hook and loop fasteners.

According to one aspect, there is provided a battery enclosure having a lower housing having two or more pockets for accepting batteries and an upper housing configured to cooperate with the lower housing. The enclosure also having a connector having two or more conductors for coupling to an electronic device and an electrical circuit configured such that when two or more batteries are inserted in the pockets all in the same orientation a potential is provided at the first connector approximately equal to the sum of the voltage of the batteries in series, the electrical circuit having an electrical component in series with the connector and a first battery to prevent the first battery from charging/discharging a second battery.

In another aspect, there is provided a battery enclosure having a lower housing having two or more pockets for holding a battery in a first orientation and a connector having two or more conductors, the connector being coupled to a selected one of the upper housing and the lower housing, the conductors coupling pairs of batteries in series, the connector having a first conductor for coupling only current through a first battery and a second battery and a separate second conductor for coupling only current through a third and fourth battery.

Although several embodiments of the invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

What is claimed is:

1. A battery enclosure, comprising:
a lower housing having two or more pockets for accepting batteries;
an upper housing configured to cooperate with the lower housing;
a first connector having two or more conductors coupleable to an electronic device; and
an electrical circuit configured such that when two or more batteries are inserted in the pockets all in the same orientation a potential is provided at the first connector approximately equal to the sum of the voltage of the batteries in series, the electrical circuit having an electrical component in series with the connector and a first battery to prevent the first battery from charging/discharging a second battery.

2. The battery enclosure of claim 1, wherein the electrical component comprises a diode.

3. The battery enclosure of claim 1, the electrical circuit further comprising a mechanical feature to prevent electrical contact from being made with a battery if the battery is installed in the wrong orientation.

4. The battery enclosure of claim 3, wherein the electrical circuit is configured to accept a battery having terminals on opposing ends.

5. The battery enclosure of claim 1, further comprising a gasket between the upper housing and the lower housing.

6. The battery enclosure of claim 1, further comprising a threaded fastener for coupling the lower housing to the upper housing.

7. The battery enclosure of claim 1, wherein a second connector couples a first battery in series with a second battery and couples a third battery in series with a fourth battery, the output of the first and the second batteries and the output third and the fourth batteries coupled to the first connector.

8. The battery enclosure of claim 7, wherein at least 50% of the height of a battery is below an upper surface of the lower housing before the upper housing is secured to the lower housing.

9. The battery enclosure of claim 8, wherein at least 60% of the height of a battery is below the upper surface of the lower housing before the upper housing is secured to the lower housing.

10. The battery enclosure of claim 1, further comprising a retainer coupling the lower housing to the upper housing.

11. The battery enclosure of claim 1, wherein the lower housing has one or more contacts in mating alignment with one or more contacts in the upper housing to complete the electrical circuit.

12. A battery enclosure, comprising:
a lower housing having two or more pockets for holding a battery in a first orientation; and
a connector having two or more conductors, the connector being coupled to a selected one of the upper housing and the lower housing, the conductors coupling pairs of batteries in series, the connector having a first conductor for coupling only current through a first battery and a second battery and a separate second conductor for coupling only current through a third and fourth battery.

13. The battery enclosure of claim 12, wherein the connector is part of an electrical circuit configured such that when two or more batteries are inserted in the pockets in the first orientation a potential is provided at the connector approximately equal to the sum of the voltage of the batteries in series.

14. The battery enclosure of claim 12, wherein the electrical circuit electrically couples additional batteries inserted in pairs to provide approximately the same output voltage.

15. The battery enclosure of claim 12, further comprising a mechanical feature to prevent electrical contact from being made with a battery if the battery is installed upside down.

16. The battery enclosure of claim 12, the electrical circuit further comprising a diode in series with the connector.

17. The battery enclosure of claim 12, further comprising a gasket for forming a water-tight seal between the upper housing and the lower housing.

18. The battery enclosure of claim 12, further comprising a threaded fastener for coupling the lower housing to the upper housing.

19. The battery enclosure of claim 12, further comprising a retainer coupling the lower housing to the upper housing.

20. The battery enclosure of claim 12, wherein at least 50% of the height of the battery is below the upper surface of the lower housing before the upper housing is secured to the lower housing.
